(19) United States
(12) Patent Application Publication
(10) Pub. No.: US 2022/0286491 A1
(43) Pub. Date: Sep. 8, 2022

(54) METHOD FOR THE DIRECT RECORDING AND STREAMING OF AI GENERATED DIGITAL CONTENT FROM A PRODUCT APPARATUS ASSOCIATED WITH UNIQUE IDENTIFICATION

(71) Applicant: Angelica Figueiredo White, Johns Creek, GA (US)

(72) Inventor: Angelica Figueiredo White, Johns Creek, GA (US)

(21) Appl. No.: 17/750,394

(22) Filed: May 23, 2022

Related U.S. Application Data
(63) Continuation-in-part of application No. 14/537,888, filed on Nov. 10, 2014.
Application No. 14/537,888 is a continuation-in-part of application No. 17/719,701, filed on Apr. 13, 2022.
(60) Provisional application No. 63/123,699, filed on Dec. 10, 2020.

(51) Int. Cl. H04L 65/60; H04L 67/10

(52) U.S. Cl. CPC H04L 65/60; H04L 67/10

(57) ABSTRACT

A method and apparatus for the direct streaming of video or audio generated using Artificial Intelligence Generative Adversarial Networks (GAN) via mobile devices, wearable devices and mobile networks using unique identification associated to a product apparatus is disclosed, capable of receiving a text or audio as primary information, and additional parameters such as video, audio and image for AI GAN algorithms processing, which uses Machine Learning, to create the A/VR video or audio output to be associated with product unique identification. The unique identifications used by this invention can be, but not limited to these types: ZARCode, NFT (Non-Fungible Token), Uniform Resource Locator (UIRL) and Uniform Resource Identifier (URI). The unique identification can be encoded on product apparatus using visible or concealed code technologies such as Barcode, QR Code, Datamatrix, Near Field Communication (NFC)) tags, ZARImage, and other technologies leveraging AI Intelligent Imaging Processing and Optical Character Recognition (OCR).

### FIELD OF THE INVENTION

TECHNOLOGY, INTERNET OF THINGS, MIXED REALITY. This invention allows for the direct streaming of video or audio generated digital content using Artificial Intelligence Generative Adversarial Networks (GAN) via mobile devices, wearable devices and mobile networks using unique identification associated to a product apparatus is disclosed, capable of receiving a text or audio as primary information, and additional parameters such as video, audio and image for machine learning training and AI GAN algorithms processing to create the AI/VR video or audio output to be associated with product unique identification. The unique identifications used by this invention can be, but not limited to these types: ZARCode, NFT (Non-Fungible Token). Uniform Resource Locator (URL) and Uniform Resource Identifier (URI). The unique identification can be encoded on product apparatus using visible or concealed code technologies such as Barcode, QR Code, Datamatrix, Near Field Communication (NFC)) tags, ZARImage, and other technologies leveraging AI Intelligent Imaging Processing and Optical Character Recognition (OCR).

### BACKGROUND OF THE INVENTION

This invention is in the field of Internet of Things and Mixed Reality. The exponential growth of digital contents, user generated digital contents created a challenge and opportunity for how the physical and digital world can connect. As video content become the preferred way for consumers to learn about new products and consume information, brands worried on how to make it possible with minimum impact to products and packaging recycling ability. Take in consideration a recent sales statistic founding that 43% of people want to see more video content from marketers and the current social media platform issues with bullying, hate that exposes brands and their customers, in addition to adversarial and competitors advertising being served along brands contents. Amid high competition for consumers attention on digital platforms, brands want to increase viewership of its contents and engagement with consumers to achieve greater ROI on their video investments.

Privacy is a growing trend, and the personalization of products powered by digital content, the Internet of Things, while highly desired, it needs to take in consideration consumers growing concerns with data mining of their activities. The personalization of products with unique video messages, with privacy and securely stored and transmitted are requirements for this innovation, particularly when addressing the needs in digital health, such as with the introduction of personalized prescription instructions in video. Personalized Prescription Instructions in video were unforeseen prior to this application's inherent patents. Most patients trash their prescription instructions without reading it, therefore not available when most needed. Most patients have difficulty reading the prescription instruction printed information, therefore making prescription instructions in video is a great improvement in educating patients on prescribed treatment and as well to increase their adherence to treatments. The access to physicians by sales reps to educate physicians on new treatments so they can recommend to their patients has become more difficult, particularly since Covid-19 Pharmaceutical companies rely on physicians to recommend their new drugs and treatments. This invention therefore can also assist sales organizations with AI GAN generate at scale personalized video messages associated with product apparatus, printed media, or digital asset.

This invention allows for personalization of video at scale to engage consumers and patients with unique video messages generated by Artificial Intelligence (AI) Generative Adversarial Networks (GAN) technology, also known as Deep Fake technology, from a product apparatus carrying a unique identification. It allows for personalized prescription instructions in video from e-prescription, text, audio or video input information to the AI GAN model.

It provides a more realistic and personalized electronic communication with a platform for consumer or patient engagement from a product apparatus carrying the unique identification.

This invention makes use of Ethical Deep Fake technology to generate VR video or VR audio contents at scale from a text information inputted or extracted from an audio file. The generated AI synthetic video or AI synthetic audio is linked with the unique identification associated with a product apparatus, printed media or digital asset unique enabling the direct streaming of this synthetic digital content. A customizable platform for consumer engagement from the AI/VR digital content engagement is also available. The unique identifications used by this invention can be, but not limited to these types ZARCode, NFT (Non-Fungible Token), Uniform Resource Locator (URL) and Uniform Resource Identifier (URI).

### BRIEF SUMMARY OF THE INVENTION

This invention provides a method and apparatus for the direct creation of AI GAN generated digital content via mobile devices, wearable devices and mobile networks using a unique identification associated to a product apparatus, printed media or digital asset.

A method and apparatus for the direct recording and streaming of AI GAN digital content via mobile devices and mobile networks from a unique identification is disclosed. In an embodiment, a product provider unique identification is for AI/VR digital content creation, storage and retrieval. A mobile device or wearable device user of the application, as a message creator scans a product apparatus carrying unique identification and validates if it is a valid unique identification, and if there is a digital content associate with the unique identification, in this case it initiates the direct streaming of the content from the cloud digital content management system to mobile or wearable device media player. If no digital content is found the application enables the input of a primary information in text or audio, and additional information such as sample video, audio, and image to be used by the AI GAN model to generate the AI/VR video or audio to be associated with unique identification. Other messages parameters may be entered for this digital content. A notification is sent to the message creator when the AI/VR video is available for viewing.

A customizable engagement platform may be defined for the AI/VR digital content generated, to allow content viewers to engage with a plurality of engagement options.

A mobile device or wearable device user of an application as recipient captures the product or digital asset unique identification and validates if it is a valid unique identification for the direct streaming of digital content. If a valid unique identification then the application will validate if there is a digital content associated with this unique identification and initiates the direct streaming of digital content from the cloud digital content management system to the mobile device or wearable device media player without intervening steps. The digital content may be AI/VR generated content. If no message is available for this unique identification, then application prompts user to create the digital content, which can be a recorded or uploaded media, parameters for the AI/VR video generation. The selected unique identification is used for message retrieval and the direct streaming of digital content without intervening steps. The selected message's engagement platform becomes available and allows viewers to access product information, create message replies, save to their personal library, buy product, provide referrals, social sharing, access to websites, access to support and other engagement options determined for that message.

A Digital Content Management System is responsible for unique identification administration, digital content management and user's personal libraries administration. Viewers are not required to create an user accounts for accessing digital content associated with product apparatus, printed media or digital asset carrying encoded unique identification, where encoding can be done using visible or concealed technologies such as Barcode, QR Code, Datamatrix, NFC tags, ZARImage, and other technologies leveraging AI Imaging Processing and OCR technologies.

AI GAN Digital content is linked to a unique identification where unique identification can be, but not limited to these types ZARCode, NFT (Non-Fungible Token). Uniform Resource Locator (URL) and Uniform Resource Identifier (URI).

### BRIEF DESCRIPTION OF THE SEVERAL VIEWS OF THE DRAWING

Features and advantages of the present invention will become apparent from the following description of pictures thereof, by way of example only, to the accompanying drawings, in which:

FIG. 1 shows the schematic diagram illustrating elements engaged in the unique identification digital content creation and direct delivery over a mobile device, wearable devices and mobile network from its extraction and reading from a product apparatus, printed media, or digital asset, where digital content is generated using AI Generative Adversarial Networks.

FIG. 2 show the diagram of how AI Generative Adversarial Network works to generate a synthetic digital content, also known as deep fake.

FIG. 3 shows a workflow diagram for the process of creating an AI VR digital content for a product unique identification as presented in this invention.

FIG. 4 shows a workflow diagram for the process of streaming AI/VR digital content from decoding, extraction or reading of unique identification associated with products apparatus or digital assets as presented in this invention

FIG. 5 shows a workflow diagram for the process of creating an AI VR digital content for a dynamically generated unique identification as presented in this invention.

FIG. 6 shows a workflow diagram for the process of managing personal library of users with registered account, as presented in this invention.

FIG. 7 shows the schematic diagram illustrating elements engaged in the unique identification digital content creation and direct delivery over a mobile device, wearable devices, and mobile network where digital content is generated using AI Generative Adversarial Networks. In this figure illustrates the customizable engagement overlay to the media player and the different forms that unique identifications supported by this invention can be encoded, recorded or embedded to products, printed media and digital assets using visible and concealed code technologies is shown

FIG. 8 shows workflow for bulk generation, or batch creation process of unique identification used by this invention to enable the direct recording and streaming of digital contents from products and digital assets, without intervening steps.

FIG. 9 shows workflow for on demand generation of unique identification used by this invention to enable direct recording and streaming of digital contents from products, printed media, and digital assets, without intervening steps.

FIG. 10 shows workflow for managing the unique identifications used by this invention to enable direct recording and streaming of digital contents from products and digital assets, without intervening steps.

### DETAILED DESCRIPTION OF THE INVENTION

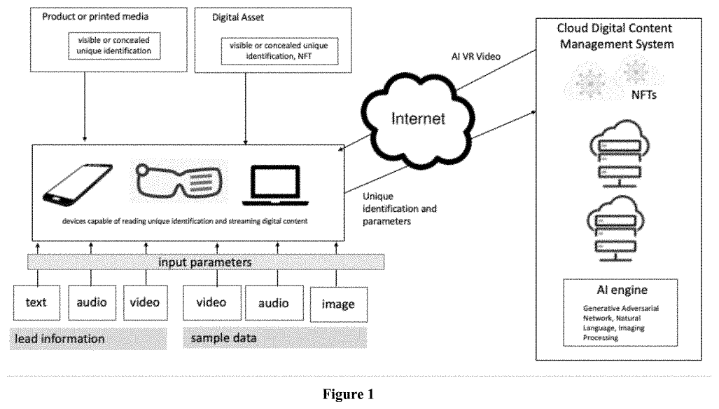

FIG. 1 shows the schematic diagram illustrating elements engaged in direct creation and direct streaming from products, printed media and digital assets carrying unique identification, of digital contents generated using AI GAN, also know deepfake or synthetic digital content. A lead information is inputted or uploaded, and it can be a text, audio or video to be used by the Generator Neural Network to create copies in the likeness of the sample data. A sample data, or master data type video, audio or image is also uploaded or referred to be used by the Discriminator Neural Network, which will compare copy generated against sample data. These two neural networks will compete against each other, until the Generator Neural Network produced a version very closely matching to the sample data. The output of this AI GAN model or engine is a synthetic digital content that will be associated to unique identification on products apparatus, printed media, or digital assets. It is done by means of mobile or wearable devices to capture encoded or recorded unique identifications and executing its processes over mobile networks, where unique identification is encoded using visible or concealed technologies such as QR Code, Datamatrix, NFC tags, ZARImage and other AI imaging processing technologies with OCR capabilities. The unique identification can be represented using ZARCode, a technology from related prior patent application, NTF, unique URL and URI technologies, but not limited to them. Product's barcodes can also be used for the direct recording and streaming of digital contents when associated with unique identifications supporting this invention. Brands can leverage existing products packaging to enable the direct streaming of AI GAN generated digital content. This invention also allows for the creation and showing of customizable engagement options overlay to digital contents media player. Options for engagement can include but not limited to websites, social media channels, phone number, emails, Application Protocol Interfaces (APIs), barcode integration for further product information with optional integration to GS1 datalink. The engagement overlay may have a background image, a logo or product image uploaded for its background with initial opacity level determined by the user creating the message. Engagement options have icons that can be resized and positioned on the content overlay as desired by the message creator. The engagement option titles, icons and activation links are customizable. Unique identifications using NFT makes uses of blockchain technologies.

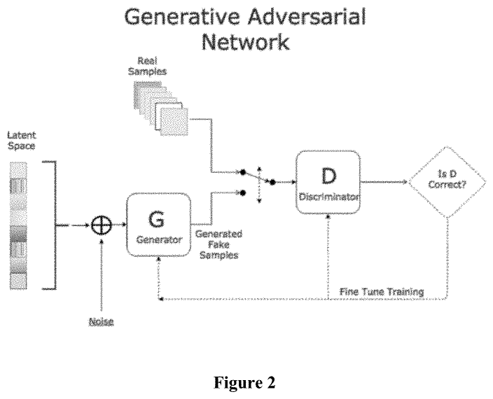

FIG. 2 shows the schematic diagram illustrating how AI GAN works to create the synthetic digital content. A lead information or fake samples is inputted or uploaded, and it can be a text, audio or video to be used by the Generator Neural Network to create copies in the likeness of the real sample data. A sample data, or real data can be type video, audio or image, which is also uploaded or referred to be used by the Discriminator Neural Network. The Discriminator will increasingly become better in identifying the fake sample created by the Generator. The Generator will become increasingly better in creating a fake sample that looks like the real sample. The competition ends when the Discriminator can't identify Generator sample as fake. These neural networks make use of AI Machine Learning. The output of this AI GAN model or engine is a synthetic digital content that will be associated to unique identification on products apparatus, printed media, or digital assets. An example of this invention business application is the generation of personalized prescription instructions in video from a e-prescription information provided as input, and a master sample video of a pharmacist of physician. The AI GAN will generate the likeness of the master sample but instead communicating the inputted e-prescription information.

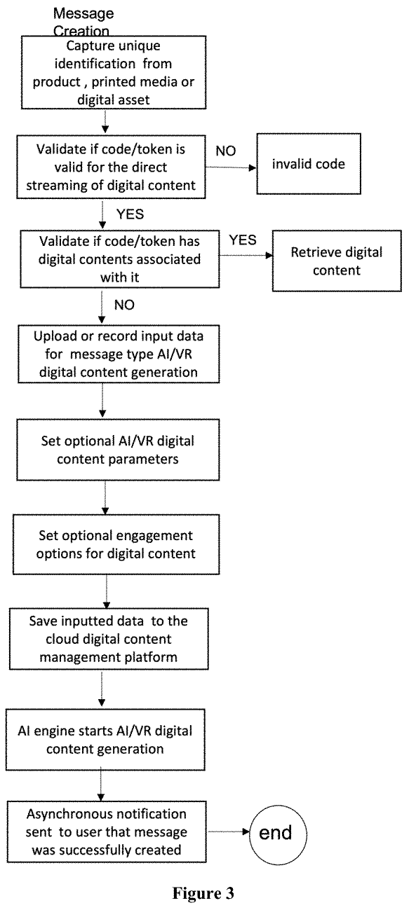

FIG. 3 shows the workflow for message creations with digital content generated by AI GAN and associated with products, printed media, and digital assets carrying an unique identification that can be a Non-fungible token. made of the following steps: 1). Capture unique identification encoded using visible or concealed technologies to product apparatus, printed media, or digital assets; 2) Extract unique identification data and validate if it is a valid code enabling the direct streaming. If unique identification is an NFT then validate against blockchain platform; 3) Check if unique identification has digital content associated with it; If true then retrieve and initiate the direct streaming of digital content 4) if no message exists then prompt user to enter input information to be submitted to the AI GAN engine to generate the digital content, a video or audio content. 5) Set optional AI/VR digital content parameters; 6) Set optional engagement options for digital content; 6) Save digital contents to the unique identification on the cloud Digital Content Management System; 7) AI engine starts AI/VR digital content generation and synthetic digital content output is associated to the unique identification; 8) An asynchronous notification is sent to user that message was successfully created.

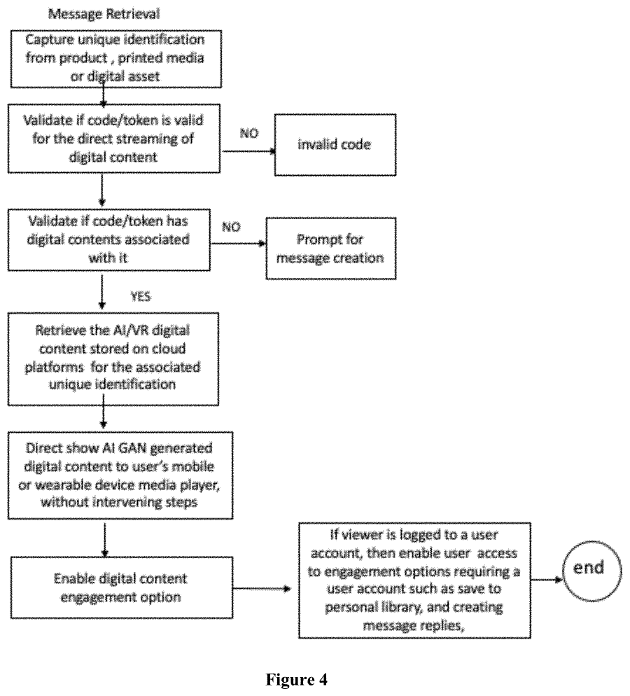

FIG. 4 shows the workflow for AI GAN digital content message retrieval from a product apparatus, printed media, or digital asset encoded or embedded with unique identification. 1) Capture unique identification from product, printed media or digital asset; 2) Validate if code/token is valid for the direct streaming of digital content; If not then an error message is shown to the user. 3) For valid codes now verify if it has digital contents associated with it; If not then prompt user to AI GAN message creation 4). Retrieve the AI/VR digital content stored on cloud digital content management system for the associated unique identification; 5) Direct show AI GAN generated digital content to user's mobile or wearable device media player, without intervening steps; 6) Enable digital content engagement option; 7) If viewer is logged to a user account, then enable user access to engagement options requiring a user account such as save to personal library, and creating message replies.

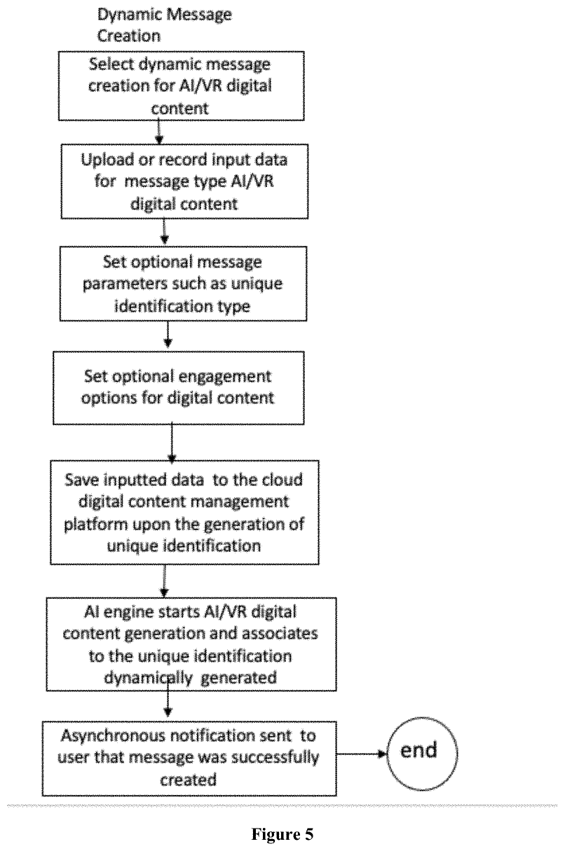

FIG. 5 shows the workflow for dynamic message creation for digital content generated using AI GAN algorithms associated with products, printed media, and digital assets carrying unique identification. The unique identification can be a Non-fungible token, made of the following steps: 1). Select dynamic message creation for AI/VR digital content; 2) Upload or record input data for message type AI/VR digital content; 3) Set optional message parameters such as unique identification type 4) Set optional engagement options for digital content; 5) Save inputted data to the Cloud Digital Content Management Platform upon the generation of unique identification; 6) AI GAN engine starts AI/VR digital content generation and associates the synthetic digital content created to the unique identification dynamically generated; 7) An asynchronous notification is sent to user that message was successfully created;

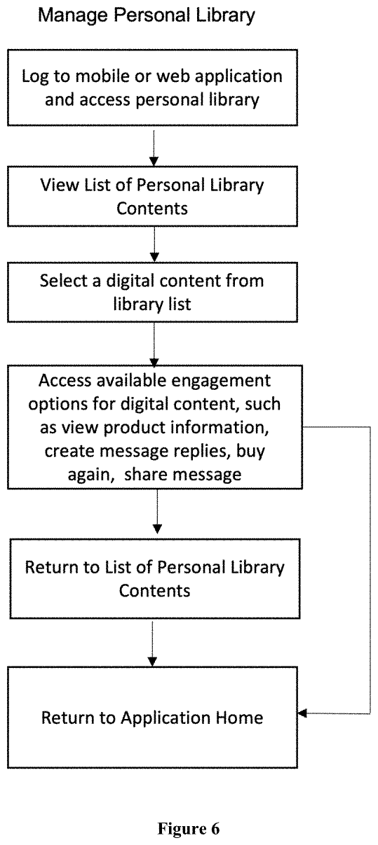

FIG. 6 Shows the workflow for the management of the personal library by a registered user. The workflow consists of the following steps: 1) Log to mobile or web application and access personal library; 2) View List of Personal Library Contents; 3) Select a digital content from library list; 4) Access available engagement options for digital content, such as view product information, create message replies, buy again, share message. It allows for directly returning to Application Home page; 5) Return to List of Personal Library Contents; 6) Return to Application Home.

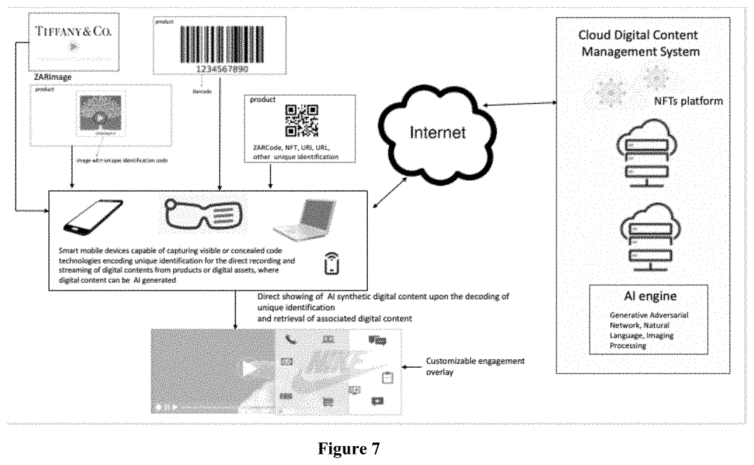

FIG. 7 shows examples of encoding technologies used for recording, embedding, or concealing unique identifications used in this invention supporting the direct recording and streaming of AI GAN generated digital contents associated with products or digital assets. Technologies used for encoding and decoding of unique identification are listed but not limited to two-dimensional barcodes, NFC tags, RFID tags, ZARImage, AI Imaging processing technologies with OCR capability. The unique identification used in this invention can be a ZARCode, NFT, URL, URI.

The customizable engagement overlay can be shown on the beginning of digital content streaming, at the end of digital content streaming or at any time during the digital content streaming through user action pulling down engagement overlay. In this figure the engagement overlay is covering the media player display area. Users can adjust overlay opacity to view digital content showing on media player.

A Digital Content Management System with Blockchain, NFT and AI GAN capabilities is responsible for the management of digital contents and unique identification supported by this invention.

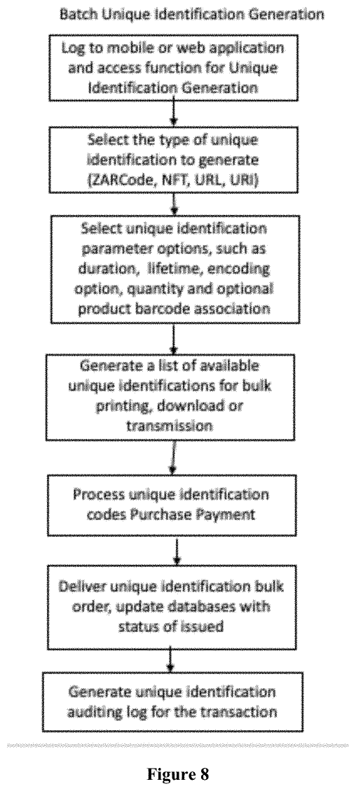

FIG. 8 shows workflow for bulk generation, or batch creation process of unique identification used by this invention to enable the direct recording and streaming of digital contents from products and digital assets, without intervening steps. The workflow consists of the following steps: 1) Log to mobile or web application and access function for Unique Identification Generation; 2) Select the type of unique identification to generate (ZARCode, NFT, URL, URI); 3) Select unique identification parameter options, such as duration, lifetime, encoding option, quantity and optional product barcode association; 4) Generate a list of available unique identifications for bulk printing, download or transmission; 5) Process unique identification codes purchase transaction; 6) Deliver unique identification bulk order as selected by user and update databases with status of issued. 7) Generate unique identification auditing log for the transaction.

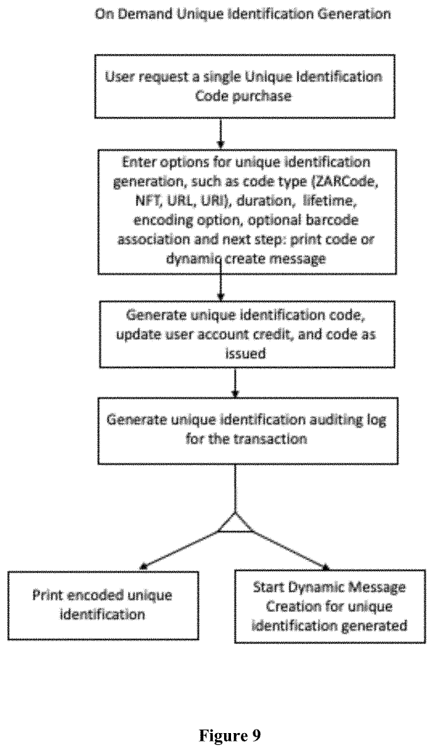

FIG. 9 shows workflow for on demand generation of unique identification used by this invention to enable direct recording and streaming of digital contents from products and digital assets, without intervening steps. The workflow consists of the following steps: 1) User request a single Unique Identification Code purchase; 2) Enter options for unique identification generation, such as code type (ZARCode, NFT, URL, URI), duration, lifetime, encoding option, optional barcode association and next step: print code or dynamic create message; 3) Generate unique identification code with selected encoding technology and output options, such as to print or to initiate message creation. Update user account credit, and updated code as issued; 4) Generate unique identification auditing log for the transaction; 5) If output option is Print then enable user to print, download or share encoded unique identification. 6) If output option was to start the creation of message, digital content, then start Dynamic Message Creation for the unique identification generated.

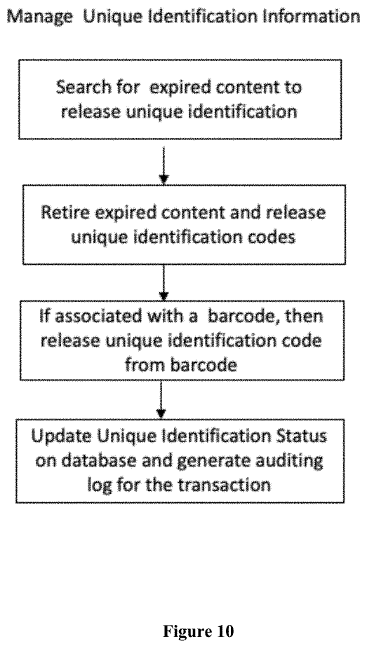

FIG. 10 shows workflow for managing the unique identifications used by this invention to enable direct recording and streaming of digital contents from products and digital assets, without intervening steps. It consists of the following steps: 1) Search for expired content to release unique identification; 2) Retire expired content and release unique identification codes; 3) If associated with barcode then release unique identification code from barcode; 4) Update Unique Identification Status on database and generate auditing log for the transaction.

What is claimed is:

1. A customer apparatus for facilitating AI GAN digital content creation and
the direct streaming of synthetic digital content from a product provider artifact, printed media or digital asset carrying a unique identification, comprising:
a method operatively hosted on a mobile or wearable device, the device comprising at least one processor operatively connected to at least one cloud digital content management system via a mobile telecommunication network, wherein the at least one mobile or wearable device processor is configured to:
capturing a visible or concealed encoded information and extracting unique identification data;
validating unique identification data to allow the AI GAN digital content creation and/or the direct streaming of synthetic digital contents;
creating synthetic digital content using AI GAN and associating synthetic digital content with the unique identification;
retrieving synthetic digital content from the at least one cloud digital content management system upon the extracting and validation of unique identification;
directly streaming synthetic digital content obtained from the at least one cloud digital content management system via the mobile telecommunication network upon the reading of unique identification.

2. The method in accordance with claim 1, wherein the at least one mobile or wearable device processor is configured for reading visible unique identification such as those encoded to QR Code, Datamatrix and Barcodes on a product provider artifact, printed media or digital asset for the direct creation and streaming of AI GAN generated digital content.

3. The method in accordance with claim 1, wherein the at least one mobile or wearable device processor is configured for reading concealed unique identification such as those recorded to NFC tags, embedded to ZARImage and encoded to QE Code on a product provider artifact for the direct creation and streaming of AI GAN generated digital content.

4. The method in accordance with claim 1, wherein the unique identification can be type NFT token, ZARCode, URI and URL.

5. The method in accordance with claim 1, wherein the synthetic digital content has a customizable engagement options platform as an overlay to the mobile device media player, for digital content engagement upon its streaming.

6. The customer apparatus in accordance with claim 1, wherein the mobile or wearable device reads the product provider artifact or digital asset unique identification and enables the creation of AI synthetic digital content associated with said unique identification.

7. The method in accordance with claim 1, wherein the mobile or wearable device reads the product provider artifact or digital asset unique identification and enables the direct streaming of AI synthetic digital content associated with said unique identification.

8. The method in accordance with claim 1, wherein the AI synthetic digital content has a customizable engagement platform as an overlay to the mobile device media player for AI synthetic digital content engagement upon its streaming.

9. The customer apparatus in accordance with claim 1, wherein said cloud digital content management system is for processing mobile or wearable application transactions over the mobile telecommunication network; for the administration, generation, and storage of digital content and unique identifications key associated with a product provider artifact, printed media, or digital asset.
